(19) United States
(12) Patent Application Publication
(10) Pub. No.: US 2015/0007483 A1
(43) Pub. Date: Jan. 8, 2015

(54) Bladed Fishing Lure

(71) Applicant: David Lynn Thorne, Kaysville, UT (US)

(72) Inventor: David Lynn Thorne, Kaysville, UT (US)

(21) Appl. No.: 14/120,871

(22) Filed: Jul. 7, 2014

Related U.S. Application Data
(63) Continuation-in-part of application No. 11/656,099, filed on Jan. 22, 2007, now abandoned.

(51) Int. Cl. A01K 85/00; A01K 85/16

(52) U.S. Cl. CPC A01K 85/00; A01K 85/16
USPC 43/42.03; 43/42.39

(57) ABSTRACT

A bladed weighted fishing lure is provided in which the blade is designed to oscillate side-to-side during retrieval and is loosely, but securely affixed to a wireform. The wireform includes an inferior portion that is rigidly secured to a weighted body and includes a medially placed feature for attachment of a fishing line. The weighted lure body includes a forward end and a back end. The oscillating action of the blade creates a unique motion of the weighted lure body creating two degrees of freedom. The first degree of freedom results from the side-to-side blade motion affecting a like side-to-side motion in the weighted lure body through the rigidly attached wireform. The second degree of freedom results from the loosely attached blade, having sufficient mass that as it oscillates side-to-side, as it comes in contact with the wireform creating a “hammer” effect during each oscillation, the resulting contact is transferred through the wireform and rigidly attached weighted lure body to create a laterally opposing side-to-side motion in the front portion and back portion of the lure. A hook may be attached to the weighted lure body.

### CONTINUITY

This application is a Continuation-in-Part of U.S. patent application Ser. 11/656,099, titled FISHING LURE ASSEMBLY and filed Jan. 22, 2007 by David L. Thorne.

### FIELD OF INVENTION

This invention relates generally to fishing lures, and more particularly to fishing lures that includes an oscillating blade, a wireform acting as a mast for the blade and weighted lure body having a complex and unique action produced by the side-to-side motion of the blade and contact between the blade and the wireform.

### BACKGROUND AND RELATED ART

There are many types of lures designed to attract fish. A snag resistant fishing lure is disclosed in U.S. Pat. No. 7,726,062 B2, issued Jun. 1, 2010 to James Ronald Davis (Davis). Davis discloses a jig with an attached blade. The jig has a weight molded about the shank of a hook with an eyelet disposed to maintain the sharpened point of a hook held upright by the relative dispositions of the eyelet, weight and orientation of the point. The blade is taught to be affixed to the eyelet, and to be limited in oscillation by either collision of the blade with the eyelet or with the weight to which it is directly affixed. Further, the blade is taught to comprise three holes, one of which is used to securely affix the blade to the eyelet. The other two holes are taught to be used in cooperation with a clip affixed to a fishing line for the purpose of releasibly affixing the fishing line of a fishing lure unit which comprises both blade and weighted fishing lure.

Wuensch et al., U.S. Pat. No. 8,028,465 B1, teaches a fishing lure and method of assembly comprising a lip, an eyelet extending forward of the lip. The eyelet being adapted to be attached to the fishing line for pulling the fishing lure through the water in a direction of movement towards the lip such that the lip imparts a movement to the fishing lure. Additionally, a buoyant or neutrally buoyant paddle extending from, and rigidly attached to the lip, having opposed side surfaces that together counterbalance the movement imparted by the lip. The invention includes a hook having a shank that is fixedly attached to and extends from the paddle.

### Definitions:

For purposes of this disclosure, the following definitions apply:
aft, adv, near, toward, or in the rear of a lure away from a line of attachment.
blade, n, a broad flattened part which is affixed to a portion of a fishing lure and which oscillates as the lure is propelled in water to provide a wake following therefrom; such a blade may be rigid or flexible, if flexible such a blade requires a supporting mast to withstand pressure from being displaced through water.
centrally, adv, near, toward the center of gravity, syn: medially.
distal, adj, (see also proximal) indicates the segment of a device normally away from a line attachment of a lure.
fishhook, n, a device, usually made of rigid metal wire, comprising a curved section which has a sharpened point on one end for catching a fish and a shank which comprises a substantially straight portion on an opposite end. Generally, the shank is ultimately affixed with an eyelet and/or split ring to the lure or it may be directly and rigidly affixed to the back portion of the lure.
fishhook assembly, n, a combination of a fishhook and other optional attributes associated with the fishhook for attaching the fishhook to a frame or wireform and for adding attractive components such as an artificial or natural bait.
fore, adv, in, toward or adjacent to the front (i.e. forward) toward a line of attachment.
inferior, adj, situated lower down or closer to the center of the earth than a referenced site.
jig, n, a fishhook which has a weight affixed about an associated shank of the fishhook.
proximal, adj, indicates the segment of a device normally closely disposed relative to a line attachment of a lure.
shank, n, a wire form which is a proximal portion of a fishhook the shank usually having a substantially straight portion which is associated with a curved portion of a fishhook and with a connecting link by which the fishhook is affixed to other fishing gear.
substantially, adv, in a manner relating to the most or main part or characteristic of something.
superior, adj, situated higher up or away from the center of the earth relative to a referenced site.

### BRIEF SUMMARY AND OBJECTS OF THE INVENTION

In brief summary, this novel invention for a weighted fishing lure assembly comprises an oscillating blade, a wireform having a medially placed feature for connecting a fishing line and an inferior portion rigidly and securely affixed centrally to a weighted lure body. The wireform may also include a clasp for maintaining the blade properly positioned above the weighted lure body such that when drawn through the water, the blade oscillates side-to-side. The weighted lure body may include an affixed hook or loosely affixed hook such as a treble hook.

Primary to the invention is the interaction of the oscillating blade with the wireform to create a lateral side-to-side motion in the weighted lure body. The loosely, but securely attached oscillating blade, comes in contact with the wireform and having sufficient mass creates a “hammer” effect during each oscillation, the resulting energy of the contact is transferred through the wireform that is rigidly and securely attached to the weighted lure body to create a laterally opposing side-to-side rotary motion to the front and back portions of the weighted lure body.

It is a primary objective to provide a fishing lure having two distinct motion degrees of freedom; a first motion due to yaw of an oscillating blade and a second motion due to rotary motion resulting from blade impact upon a disposed wireform.

Another objective is to provide a weighted fishing lure body that moves directly in relation to the side-to-side movement of the oscillating blade.

Another objective is to provide a hooking means attached to the weighted lure body. This may be accomplished with an eyelet and hook or a single hook only having a shank that is rigidly attached to the back portion of the lure.

It is an important object to provide a blade member that is securely, but pivotally affixed to the wireform such that the blade is permitted to oscillate as the lure is displaced through water.

These and other objects and features of the present invention will be apparent from the detailed description taken with reference to accompanying drawings.

### BRIEF DESCRIPTION OF THE DRAWINGS

FIG. 1 is a side elevation of a fishing lure made according to the instant invention.

FIG. 2 is a perspective of the fishing lure seen in FIG. 1, rotated.

FIG. 3 is a frontal elevation of a blade portion of the fishing lure seen in FIGS. 1 and 2.

FIG. 4 is a side elevation of a wireframe and an associated blade made according to the instant invention.

FIG. 5 is a side elevation of a fishing lure similar to the fishing lure seen in FIG. 1, but with a treble hook.

FIG. 6 shows a side elevation of a simplified wireform made according to the present invention.

FIG. 7 is a side elevation of the wireform made according to the present invention and a blade disposed in a first assembly step.

FIG. 8 is a side elevation of the wireform and blade seen in FIG. 7 assembled and securely affixed together.

FIG. 9 is a perspective of a fishing lure made according to the present invention with a mode of attachment free of a slot

FIG. 10 is a perspective of the fishing lure seen in FIG. 9 rotated for a view of the aft portion of the blade.

FIG. 11 is a schematic of a blade oscillation in a yaw motion (indicated by dashed lines) showing a mode of action as the blade is drawn through water.

FIG. 12 is a schematic of a blade of the blade seen in FIG. 11 oscillating about a segment of a wireframe displaced through the blade and applying force of contact upon the segment to impart a second mode of action to the wireform as the blade is drawn through water.

FIG. 13 is a wireform made according to the present invention with a hook and a weight affixed thereto.

FIG. 14 is a fishing lure which is made by affixing a bait to the parts seen in FIG. 13.

FIG. 15 is a perspective of another embodiment of a blade, wireform, weight and hook combination.

FIG. 16 is a perspective of the combination seen in FIG. 15 rotated by a pulling force on the hook.

These and other objects and features of the present invention will be apparent from the detailed description taken with reference to accompanying drawings.

### DETAILED DESCRIPTION OF THE ILLUSTRATED EMBODIMENTS

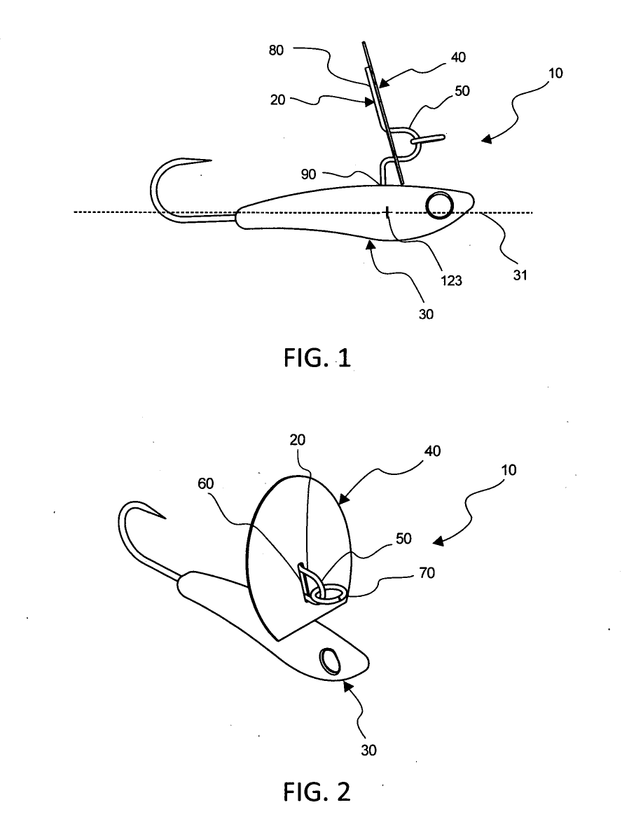

Reference is now made to the embodiments illustrated in FIG. 1-16 wherein like numerals are used to designate like parts throughout. Primes of numbers designate labeled parts which are similar in form and function to parts numbered without primes, but not identical.

As seen in FIG. 1, a fishing lure assembly 10 made according to the instant invention is seen to comprise a wireform 20, a weighted body (generally numbered 30) having a longitudinal axis 31 and a blade 40. As seen in FIG. 2, blade 40 is securely, but loosely affixed to wireframe 20 by a bend segment 50 being displaced through an elongated slot 60 in blade 40 and captured thereat by a retaining ring 70. A fishing line (not shown) may be affixed to either segment 50 or retaining ring 70.

Referring again to FIG. 1, wireform 20 comprises an elongated mast 80 which is upwardly distended to provide medially disposed aft oscillation support for blade 40. Further wireform 20 comprises an inferiorly distending portion 90 to which weighted body 30 is securely affixed.

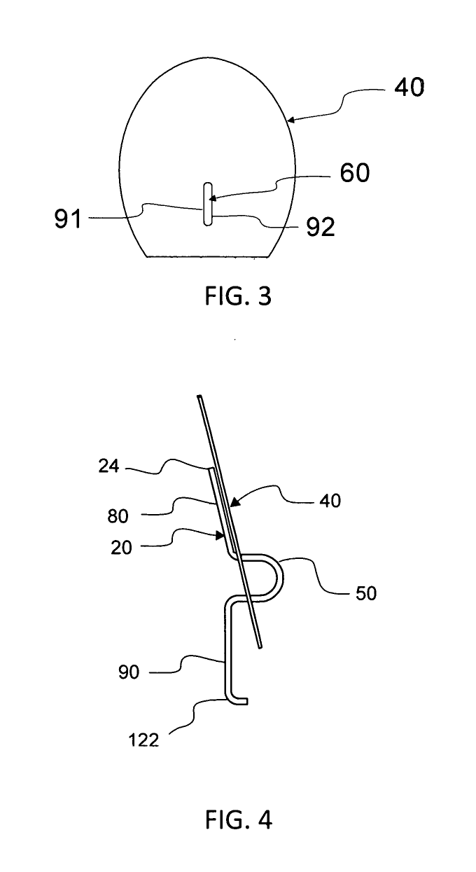

Details of blade 40 are provided in FIG. 3. Blade 40 comprises slot 60 having sides 91 and 92 and being sized and shaped to be wide enough to permit segment 50 (see FIG. 1) to be displaced there through, but sufficiently narrow to impact segment 50 as it oscillates about mast 80.

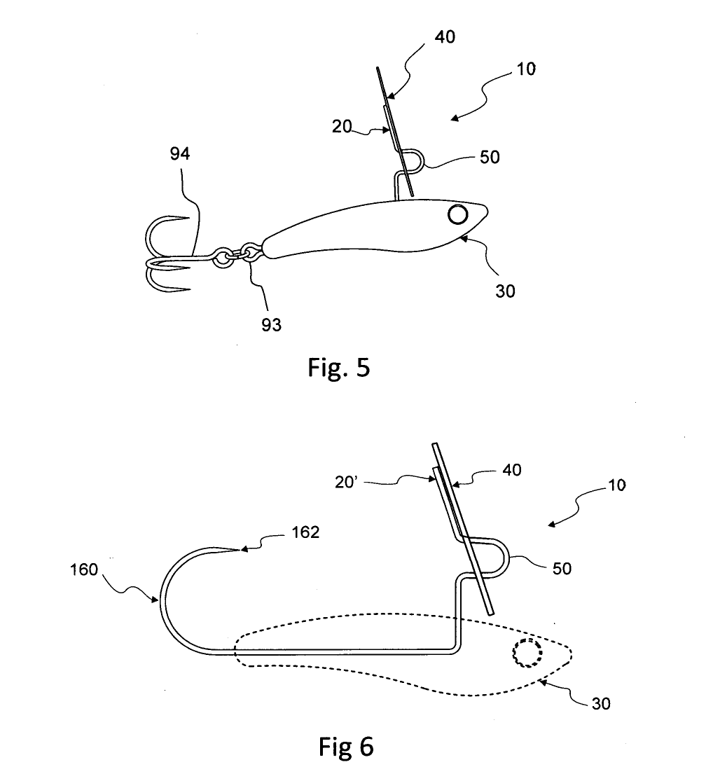

Seen in FIG. 5, is a fishing lure assembly 10 having a hook receiver 93 and a loosely connected treble hook 94.

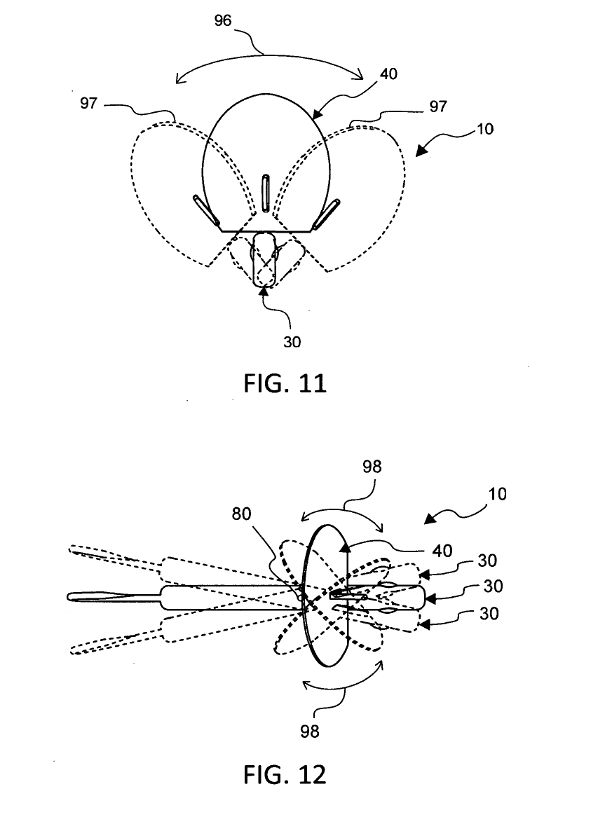

As seen in FIGS. 11 and 12, action of a lure made according to the instant invention is dependent upon two separate and distinct modes of rotational displacement, more or less horizontally as blade 40 is drawn through water. Note, a first mode of angular rotation as indicated by arrowed line 96 as blade 40 yaws. A more vertical mode of oscillation of blade 40 is seen in FIG. 12 as blade 40 is constrained to rotate about mast 80. That vertical mode of oscillation is transferred to weighted body 30 as indicated by dashed lines. The combination of these two modes of oscillation and rotation imparts a surprisingly realistic swimming motion to weighted body 30. As seen in FIG. 11, blade 40 rotates during yaw to expose edge 97 to view.

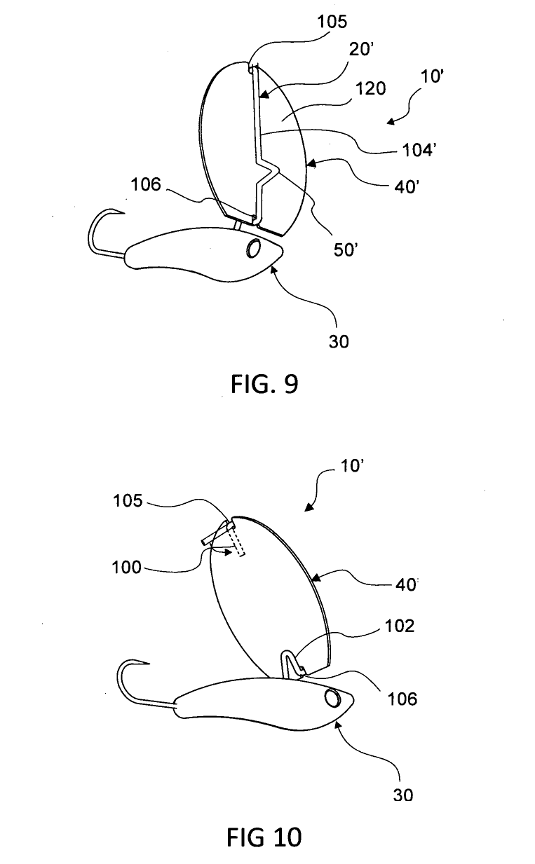

Modes of attachment of a blade by an oscillation supporting wireform may vary widely within the scope of the instant invention as seen in FIGS. 4 and 7-10. As seen in FIGS. 9 and 10, a mast of a wireframe 20′ may be imposed on a fore side of a blade 40′ of a lure assembly 10′. In this case, blade 40′ support is provided by aft disposed bended legs 100 and 102, with an upwardly distending segment 104′ of wireform 20′ disposed on the forward side of blade 40′. A superiorly disposed slot 105 and an inferiorly disposed slot 106 in blade 40′ provides affixing sites for retaining bended legs 100 and 102 respectively. Note that bended leg 100 is preferably bent into attachment after blade 40′ is in place thereat and, in this case, no slot 60 (see FIG. 3) is required in an associated blade. Note also that no retaining ring 70 (see FIG. 1) is required for affixing blade 40′ to wireform 20′. Also as seen in FIG. 9, upwardly distending segment 104′ (a part of the mast of wireform 20′ comprises an outwardly extending bend 50′ whereat a fishing line may be affixed. Slots 105 and 106 may be replaced more generally by concave indents on superior and inferior surfaces of blade 40′. Note also, that providing attached superiorly affixed support such as by attaching wireform 20′ to superior disposed slot 105, adds weight effected stability through wireform 20′ to blade 40′ and as a result to fishing lure assembly 10′.

A wireform 20 of fishing lure assembly 10 is seen without an associated weighted body in FIG. 4. Mast 80 provides oscillatory support for blade 40 about bend 50. An inferiorly distending segment 90 ends in an anchor bended leg 122. It is preferred to anchor bend 122 along a vertical plane which intersects the center of gravity 123 (as indicated by a “+” sign) of a weight affixed thereat (see FIG. 1). It is also preferred to have distending segment 90 intersect the center of gravity 123. As disclosed this attachment of a wireform to a blade requires a retention ring 70 (see FIG. 2).

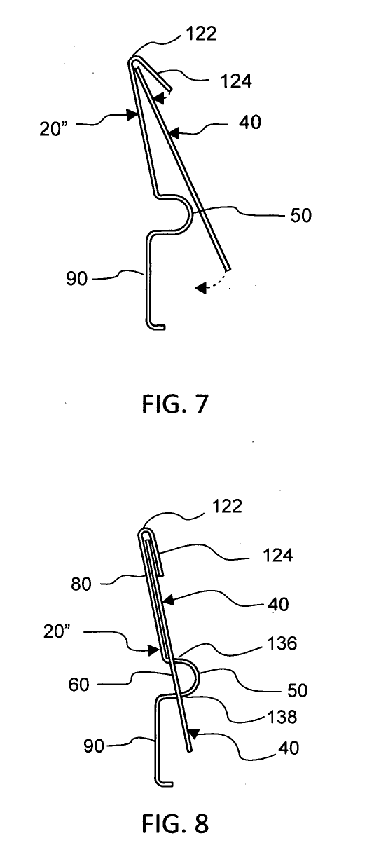

A wireform, such as wireform 20″ seen in FIG. 7, may also be affixed to a blade (such as blade 40) without a restraining component such as retaining ring 70 (see FIG. 2). Wireform 20″ comprises a superiorly disposed bended leg 122 which permits an end segment 124 to be bent to loosely affix to blade 40 (see FIG. 8). Superior wire segment 136 and inferior wire segment 138 are disposed within slot 60 of blade 40 (see FIG. 3) to maintain vertical alignment.

As seen in FIG. 6, a wireform 20′ may have a hook 160 added at an end 162.

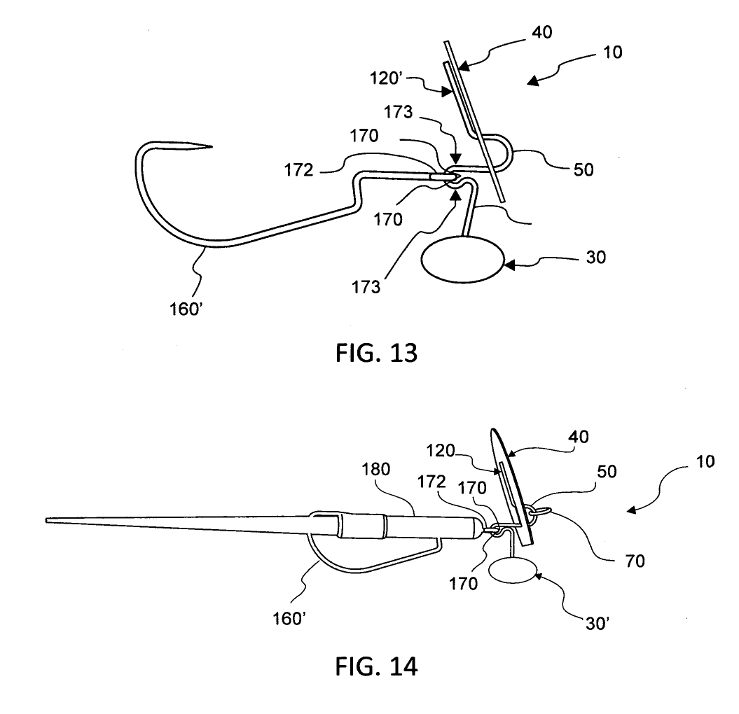

As is evident from examples provided supra, a wireform according to the present invention may be formed in numerous ways. Important are the aspects of blade support weight, connection and interaction. Another example of a wireform is wireform 120 seen in FIG. 13. Note, that a hook 160′ is affixed to wireform 120′ by compressing a loop 170 about a hook eyelet 172. Also as noted in FIG. 13, force applied as shown by arrows 173 to affix hook eyelet 172 to the wireform 120′.

A bait 180 may be affixed to hook 160′ as seen in FIG. 14.

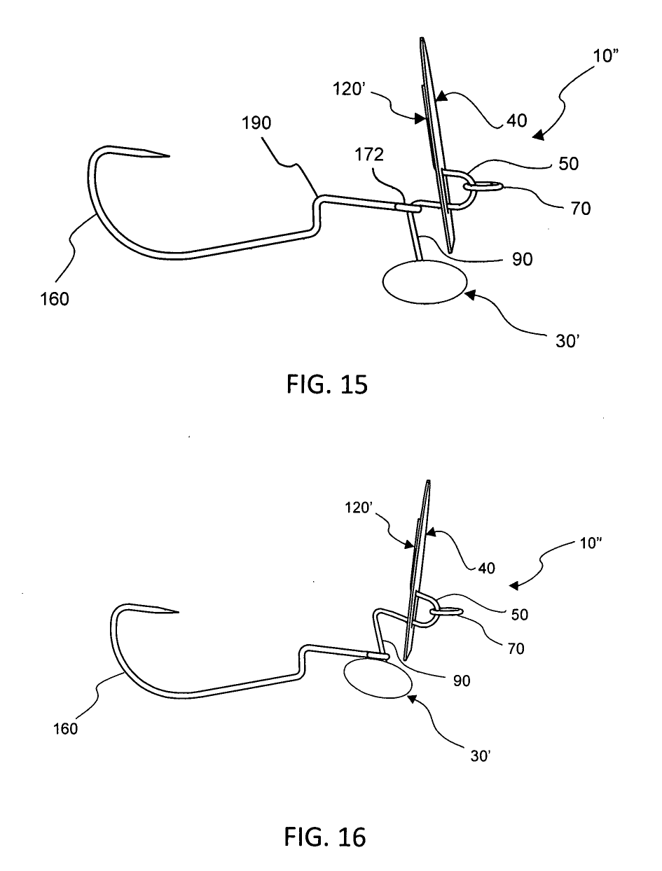

As seen in FIG. 15, hook eyelet 172 is connected to wireform 120′ and is dispersed at a superior end 190 of inferiorly distending portion 90 when drawn through water without a retarding force of a fish applied.

As seen in FIG. 16, retarding force of a fish applied causes hook eyelet 172 to move inferiorly to a site near weight 30′. Such movement tilts blade 40 and wireform 120′ such that the blade 40 is angled to effectively rise in water.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A weighted fishing lure assembly which manifests realistic swimming motion of an associated weighted lure body when displaced through water comprising, said lure assembly comprising:
a rigid wireform comprising:
a) an elongated superiorly directed extension to which a blade is securely, but loosely affixed and supported by said wireform against force of water as the lure is displaced therein;
b) a portion of said wireform which is affixed to the blade and comprises a site whereat a fishing line is affixed to define a first axis of rotation;
c) an inferiorly extended segment whereby a weighted lure body is securely and rigidly affixed to said wireform;
the blade comprising:
a) a forward surface and an oppositely disposed rearward surface, two opposing side edges, an inferiorly disposed edge and a superiorly disposed edge;
b) shape and size for oscillating and thereby causing said wireform to yaw about the first axis of rotation as the lure is displace relative to water;
c) a segment which is medially disposed relative to said side edges and about said superiorly directed extension such that said blade rotates about said superiorly directed extension to provide a second axis of rotation as the blade is displaced in water.
d) at least one opening by which said wireform is securely but loosely affixed to said blade, said at least one opening having side dimensions which periodically impact said wireform portion as the blade oscillates about the second axis of rotation.
f) sufficient mass and rigidity to provide inertia for imparting rotary motion to said wireform and fishing lure assembly;
the weighted lure body comprising an elongated longitudinal axis and a weight having a predetermined site where said inferiorly extended segment is securely and rigidly affixed, such that combined modes of motion about first and second axes of rotation impart life like swimming action to said assembly.

2. A weighted fishing lure assembly according to claim 1 wherein said predetermined site is the center of gravity of said fishing lure assembly.

3. A weighted fishing lure assembly according to claim 1 wherein said wireform portion comprises a bend which forms a mooring for a fishing line.

4. A weighted fishing lure assembly according to claim 1 wherein said fishing lure assembly comprises at least one fishing hook.

5. A weighted fishing lure assembly according to claim 1 wherein said blade and said fishing lure assembly are disposed apart such that one does not contact the other.

7. A weighted fishing lure assembly according to claim 1 wherein the blade comprises an open top slot and an open bottom slot whereby said wireform is loosely, but securely affixed.

8. A weighted fishing lure assembly according to claim 1 wherein said fishing lure assembly comprises and artificial bait, said artificial bait manifesting life like swimming action resulting from blade generated first and second axes of rotation.

9. A weighted fishing lure assembly according to claim 1 wherein said fishing lure assembly comprises a natural bait which manifests swimming motion derived from action of the first and second axes of rotation.

10. A weighted fishing lure assembly according to claim 1 wherein said weighted lure body is a jig.
